(19) United States
(12) Patent Application Publication
(10) Pub. No.: US 2004/0188153 A1
(43) Pub. Date: Sep. 30, 2004

(54) Electric motorized scooter with an electric differential

(76) Inventors: Pao-Pao Liu, Kaoshiong Hsien (TW); Chung-Yi Liao, Taichung City (TW); Kevin Cheng, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/808,527

(22) Filed: Mar. 25, 2004

(30) Foreign Application Priority Data
Mar. 27, 2003 (TW) 92107225

(51) Int. Cl. B60K 1/00

(52) U.S. Cl. 180/65.1; 180/181

(57) ABSTRACT

An electric motorized scooter includes a base having a front wheel and a rear wheel on two ends thereof, and a steering tube is rotatably connected to the base and a handle is connected to a top end of the steering tube. Two side wheels are connected to two sides of the base and driven by two motors. An electric differential includes a motor controlling unit which is electrically connected to the two motors so as to respectively control the speeds of the two motors. A steering control device includes an operation device and a steering unit which is electrically connected to the motor controlling unit. When turning the scooter, the two side wheels moves at different speeds so that the scooter can be turned at small angle.

### FIELD OF THE INVENTION

The present invention relates to an electric motorized scooter having an electric differential for controlling the speed of two side wheels when the scooter turns.

### BACKGROUND OF THE INVENTION

Conventional scooters known to applicant are respectively disclosed in U.S. Pat. Nos. 6,347,681, 6,343,667, 6,386,562 and 6,398,238. These scooters generally include a board with a steering tube extending from a front end of the board. A handle and a front wheel are respectively connected to two ends of the steering tube. A rear wheel is connected to a rear end of the board. Although some of the scooters have two side wheels, the front wheel of these scooters controls the direction of movement of the scooters. When the user turns the scooter by operating the handle, the rear wheel is dragged by the forward movement of the board, and this limits the scooters to be turned at a small angle, in other words, if the scooter moves and turns at a high speed, the rear wheel cannot perform as desired and will slide laterally.

The present invention intends to provide an electric motorized scooter which has an electric differential for controlling the speed of the two side wheels such that the scooter can be turned at a small angle.

### SUMMARY OF THE INVENTION

The present invention relates to an electric motorized scooter comprising a base with two side wheels, a front wheel connected to a steering tube and a rear wheel. A handle is connected to a top end of the steering tube. The two side wheels are powered by two motors. An electric differential includes a motor controlling unit which is electrically connected to the two motors so as to respectively control the two motors. A steering control device includes an operation device and a steering unit which is electrically connected to the motor controlling unit.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the electric motorized scooter of the present invention;

FIG. 2 is a right side view to show the electric motorized scooter of the present invention;

FIG. 3 is a left side view to show the electric motorized scooter of the present invention;

FIG. 4 is a top view to show the electric motorized scooter of the present invention;

FIG. 5 is a front view to show the electric motorized scooter of the present invention;

FIG. 6 shows the connection between the control units and the two motors of the two side wheels;

FIG. 7 shows a front view of the connection mechanism connected between the handle and the top end of the steering tube;

FIG. 8 shows a side view of the connection mechanism connected between the handle and the top end of the steering tube;

FIG. 9 shows the front wheel turns left and the rear wheel turns right; and

FIG. 10 shows the front wheel turns right and the rear wheel turns left.

### DETAILED DESCRIPTION OF THE PREFERRED EMBODIMENT

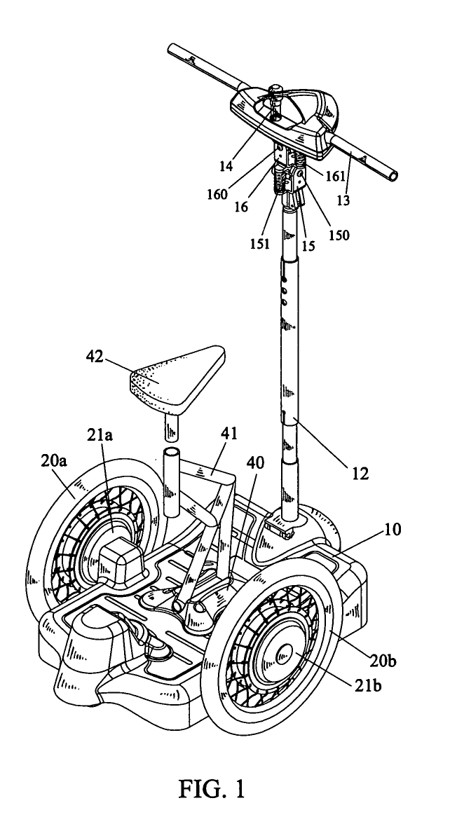

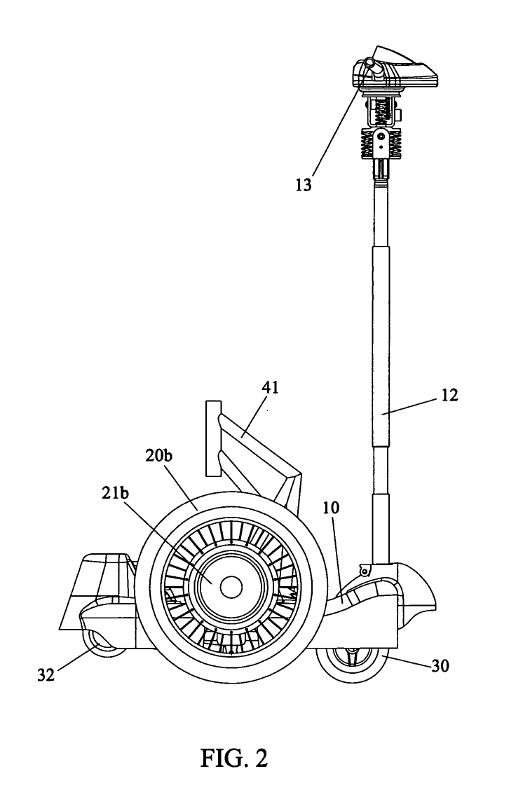

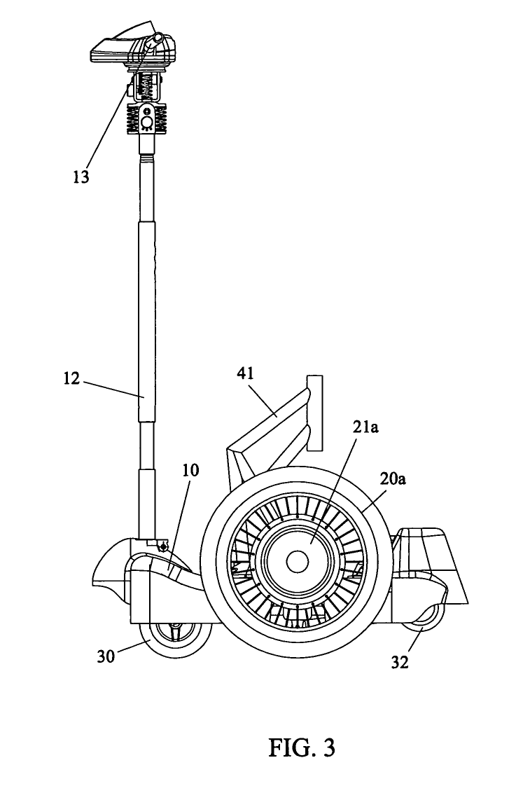

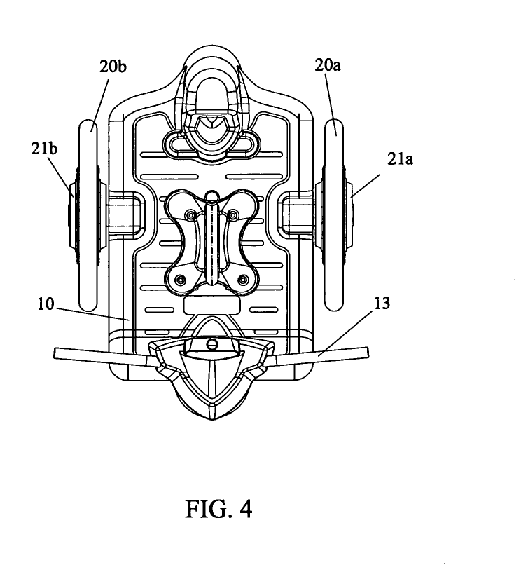

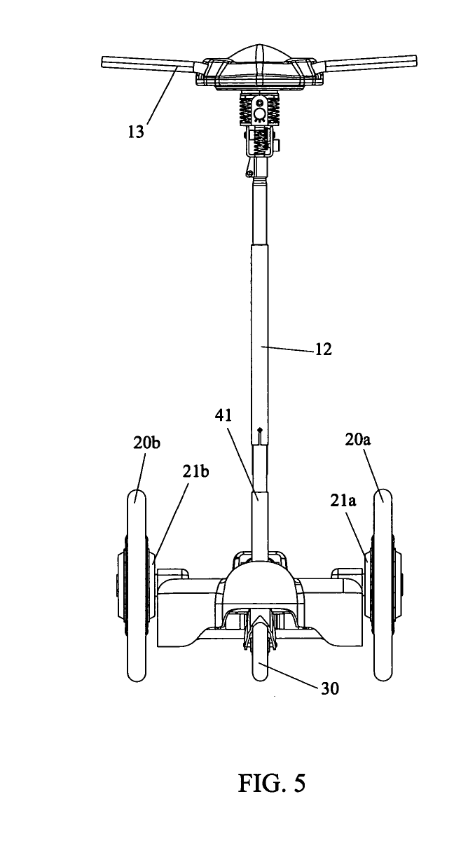

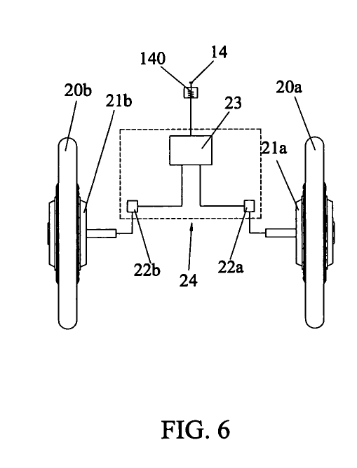

Referring to FIGS. 1 to 6, the electric motorized scooter of the present invention comprises a base 10 on which a protrusion 40 is connected on a top surface thereof and a seat post 41 is connected to the protrusion 40. A seat 42 is connected to the seat post 41. A steering tube 12 is rotatably connected to a front end of the base 10, a front wheel 30 connected to a lower end of the steering tube 12 and a handle 13 connected to a top end of the steering tube 12. A cushion device (not shown) can be connected to the front wheel 30 if needed. The front wheel 30 turns when the handle 13 turns. A rear wheel 32 is connected to an underside of a rear end of the base 10 and a cushion device (not shown) can be connected to the rear wheel 32 if needed.

Two side wheels 20a and 20b are connected to two sides of the base 10 and two motors 21a, 21b are respectively connected to the two side wheels 20a and 20b. An electric differential includes a motor controlling unit 24 which includes two motor controller 22a, 22b for controlling the two motors 21a, 21b and a main control unit 23 to which the two motor controller 22a, 22b are connected. The speeds of the two motors 21a, 21b are controlled by the two motor controller 22a, 22b.

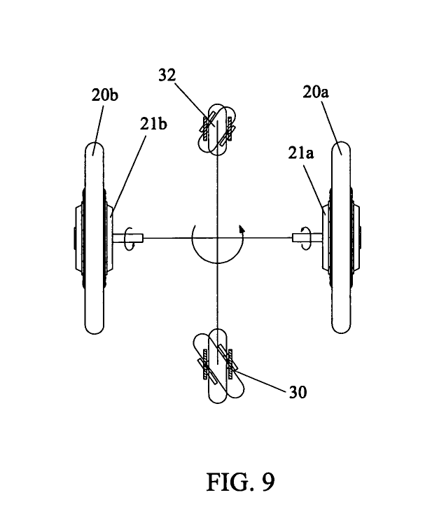

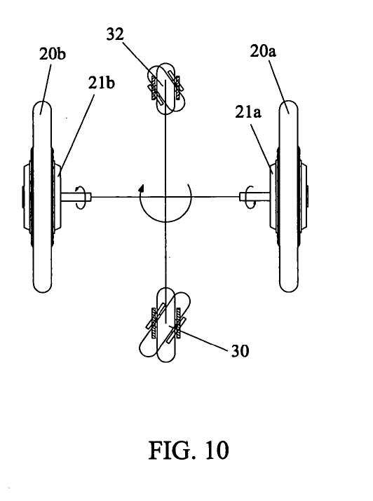

A steering control device includes an operation device 14 and a steering unit 140 which is electrically connected to the motor controlling unit 24. The user may control the scooter by operating the operation device 14 to demand the performance of the two side wheels 20a and 20b. When turning the scooter, the rear wheel 32 provides a stable movement of the scooter even if one of the two side wheels 20a, 20b does not contact the ground. As shown in FIGS. 9 and 10, when the scooter turns left and right, the rear wheel 32 assists the turning and the speeds of the two side wheels 20a, 20b are controlled to have different speeds, and this allows the scooter turns at a small angle.

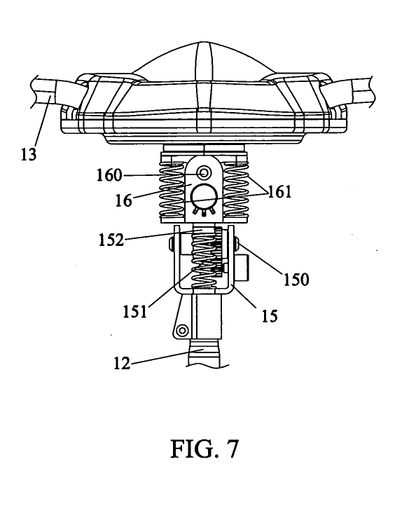

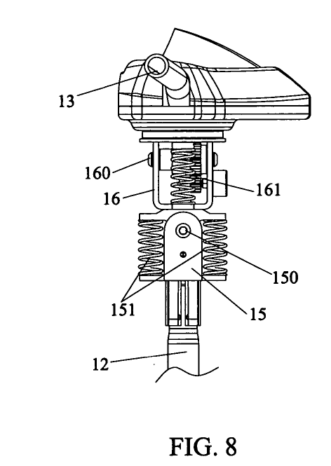

Referring to FIGS. 7 and 8, a connection mechanism is connected between the handle 13 and the top end of the steering tube 12. The connection mechanism includes a first U-shaped frame 15 and a first neck 152 is pivotally connected between two extensions of the first U-shaped frame 15 by a pin 150. Two first springs 151 are connected between the first neck 152 and an inner bottom of the first U-shaped frame 15 so that the first neck 152 can swing between the two extensions of the first U-shaped frame 15. A second U-shaped frame 16 is connected to the first neck 152 and located on a top of the first U-shaped frame 15. A second neck 162 is pivotally connected between two extensions of the second U-shaped frame 16 by a pin 160. Two second springs 161 are connected between the second neck 162 and an inner bottom of the second U-shaped frame 16 so that the second neck 162 swings between the two extensions of the second U-shaped frame 16. The connection mechanism provides proper flexibility for operating the handle 13 to operate the scooter especially for the turning. It is noted that the two side wheels 20a, 20b are located at the intermediate portion of the base 10 and are driven by the two motors 21a, 21b so that the base 10 is well supported by the two side wheels 20a, 20b, the front wheel 30 and the rear wheel 32. Because the two side wheels 20a, 20b are powered by the motors 21a, 21b, the scooter can spin by the two side wheels 20a, 20b.

While we have shown and described the embodiment in accordance with the present invention, it should be clear to those skilled in the art that further embodiments may be made without departing from the scope of the present invention.

What is claimed is:

1. An electric motorized scooter comprising:
a base (10) and a steering tube (12) rotatably connected to a front end of the base (10), a front wheel (30) connected to a lower end of the steering tube (12) and a handle (13) connected to a top end of the steering tube (12);
two side wheels (20a, 20b) connected to two sides of the base (10) and two motors (21a, 21b) respectively connected to the two side wheels (20a, 20b);
an electric differential including a motor controlling unit (24) which is electrically connected to the two motors (21a, 21b) so as to respectively control the two motors (21a, 21b), and
a steering control device including an operation device (14) and a steering unit (140) which is electrically connected to the motor controlling unit.

2. The scooter as claimed in claim 1, wherein a rear wheel (32) is connected to an underside of the base (10).

3. The scooter as claimed in claim 1 further comprising a seat post (41) on the base (10) and a seat (42) connected to the seat post (41).

4. The scooter as claimed in claim 1, wherein a connection mechanism is connected between the handle (13) and the top end of the steering tube (12), the connection mechanism including a first U-shaped frame (15) and a first neck (152) pivotally connected between two extensions of the first U-shaped frame (15), two first springs (151) connected between the first neck (152) and an inner bottom of the first U-shaped frame (15) so that the first neck (152) swings between the two extensions of the first U-shaped frame (15).

5. The scooter as claimed in claim 4, wherein a second U-shaped frame (16) is connected to the first neck (152) and located on a top of the first U-shaped frame (15), a second neck (162) pivotally connected between two extensions of the second U-shaped frame (16), two second springs (161) connected between the second neck (162) and an inner bottom of the second U-shaped frame (16) so that the second neck (162) swings between the two extensions of the second U-shaped frame (16).

6. The scooter as claimed in claim 1, wherein the motor controlling unit (24) includes two motor controller (22a, 22b) which are respectively connected to the two motors (21a, 21b), the two motor controller (22a, 22b) respectively connected to a main control unit (23).
